(19) United States
(12) Patent Application Publication
(10) Pub. No.: US 2022/0030916 A1
(43) Pub. Date: Feb. 3, 2022

(54) Pet Food

(71) Applicant: Blue Buffalo Enterprises, Inc., Wilton, CT (US)

(72) Inventors: Lisa Garretson, Minneapolis, MN (US); Natasha Weatherby, Minneapolis, MN (US); Cha Yang, Saint Paul, MN (US)

(73) Assignee: Blue Buffalo Enterprises, Inc., Wilton, CT (US)

(21) Appl. No.: 17/386,927

(22) Filed: Jul. 28, 2021

Related U.S. Application Data
(60) Provisional application No. 63/058,562, filed on Jul. 30, 2020.

(51) Int. Cl. A23K 40/30; A23K 50/42; A23K 20/158; A23K 20/163; A23K 20/147; A23K 10/30

(52) U.S. Cl. CPC A23K 40/30; A23K 50/42; A23K 10/30; A23K 20/163; A23K 20/147; A23K 20/158

(57) ABSTRACT

A pet food is described that has a veneer on a surface that is low in sugar, low in moisture, transport stable, and has a smooth appearance at room temperature. A veneer includes a non-fat solids content of about 40% to about 60% by weight of the veneer, and a fat composition in an amount of 35% to 60% by weight of the veneer.

### CROSS REFERENCE TO RELATED APPLICATIONS

This application claims the benefit of U.S. Provisional Patent Application Ser. No. 63/058,562, which was filed on Jul. 30, 2020 and titled “Pet Food”. The entire content of this application is incorporated by reference.

### BACKGROUND

Consumers are increasingly treating their pets like family members. As consumers embrace their pets as family members, products that help them treat their pets more as family members are needed.

### SUMMARY

The present disclosure relates to pet food that has a veneer on at least a portion of a surface.

A pet food is provided herein. The pet food includes a base food piece and a veneer on a surface of the base food piece. A veneer is disclosed that can include a non-fat solids content of about 40% to about 60% by weight of the veneer, a fat composition in an amount of 35% to 60% by weight of the veneer, the fat composition having a melting point of 90° F. to 140° F. and including a hard fat in an amount of up to 40% by weight of the fat composition, the hard fat having a melting point greater than 140° F., a sugar content of up to 25% by weight of the veneer; and a moisture content of less than 7% by weight of the veneer, where the veneer is transport stable at 100° F. for at least 24 hours and has a smooth appearance at room temperature.

In some embodiments, a veneer can have a protein content of at least 5% by weight of the veneer. In some embodiments, a protein content of a veneer can be from about 6% to about 30% by weight of the veneer. In some embodiments, a veneer can contain at least 10% by weight protein when the fat composition has a melting point at or above 120° F.

In some embodiments, a fat composition in a veneer can include up to 30% by weight of a liquid fat having a melting point below 90° F. In some embodiments, a fat composition in a veneer can include a hard fat in an amount of at least 2% by weight when the non-fat solids content is greater than 55%. In some embodiments, the melting point of a fat composition in a veneer can be at least 100° F. when the hard fat content of the fat composition is 0%.

In some embodiments, a veneer can include a nut butter.

In some embodiments, sugar content of a veneer can be no more than 10%. In some embodiments, sugar content of a veneer can be 0%.

In some embodiments, a veneer can contain essentially no refined sugar. In some embodiments, a pet food can contain essentially no refined sugar.

In some embodiments, a veneer can contain essentially no corn-derived, wheat-derived, or soy-derived ingredients. In some embodiments, a pet food can contain essentially no corn-derived, wheat-derived, or soy-derived ingredients.

In some embodiments, a pet food can have a shelf life of at least 6 months at room temperature.

A method of making a pet food is also provided herein. A method of making a pet food can include providing a base food piece having a surface, applying a liquid composition to the surface, and allowing the liquid composition to solidify to form a veneer on the surface to produce the pet food, wherein the veneer is transport stable at 100° F. for at least 24 hours and has a smooth appearance at room temperature. A liquid composition can include a non-fat solids content of about 40% to about 60% by weight of the liquid composition, a fat composition in an amount of 35% to 60% by weight of the liquid composition, the fat composition having a melting point of 90° F. to 140° F. and including a hard fat in an amount of up to 40% by weight of the fat composition, the hard fat having a melting point greater than 140° F., a sugar content of up to 25% by weight of the liquid composition, and a moisture content of less than 7% by weight of the liquid composition.

In some embodiments, a method of making a pet food can include producing a liquid composition. In some embodiments, a liquid composition can be produced at a temperature below 90° F. In some embodiments, a liquid composition can be produced at a temperature at or above the melting point of the fat composition.

In some embodiments, a method can further include packaging the pet food into a package.

These and various other features and advantages will be apparent from a reading of the following detailed description.

### DRAWINGS

FIG. 1 shows photographs of a veneer used a drizzle (left), a coating (middle), or a sandwiched as a filling between two base food pieces (right). The top image illustrates a control for each product (room temperature, no shaking), the middle image illustrates what a transport stable product would appear as after 24 hours at 100° F. and shaking, and the bottom image illustrates what a non-transport stable product would appear as after 24 hours at 100° F. and shaking. Transport stable veneers had no significant changes in appearance, such as smearing, melting, or shifting of pieces in a sandwiched product, after 24 hours at 100° F. and shaking.

### DETAILED DESCRIPTION

Consumers are increasingly embracing the role pets play in their families. Such consumers, sometimes referred to as “pet parents,” look for ways to meet the needs of their pets while also treating them as though they are a full member of their family. In addition to regular food, pet parents enjoy feeding their pets treats to show affection, to create interactive moments with their pets, or to reward their pets.

Although many pets enjoy foods suitable for human consumption, most pet foods, including treats, are more suitably formulated to meet the preferred tastes and/or nutritional needs of pets. One challenge in producing pet foods is to make the foods enticing to pets while also providing pet foods that help create unique and enjoyable experiences for pet parents to share with their pets.

Described herein is a new pet food that is designed to meet pet needs while also providing an enjoyable experience for pet parents. A pet food provided herein is uniquely developed to resemble foods that are normally appropriate for human consumption. A pet food provided herein includes a base food piece with a veneer on at least one surface that mimics a coating or filling on human foods. Surprisingly, a veneer on a pet food described herein provides an appealing, smooth appearance and is transport stable, despite formulation challenges as described below.

A veneer described herein can visually resemble a coating or filling on human foods, such as coating or drizzle on one or more surface of a snack bar or a cookie, a filling sandwiched between two biscuits, or the like. Such coatings and fillings on human foods typically have high sugar content, which contributes both sweetness and flavor and appearance stability during shelf life and transport. However, though pets don't necessarily need sweetness of sugar to enjoy a pet food, and extra sugar content can contribute to dental problems, making a coating suitable for pet consumption is not a matter of simply reducing sugar content of a coating suitable for human food to make it suitable for pets. Because sugar, particularly sucrose, plays a significant role in their structure and functionality, including providing stability during shelf life and an appealing appearance, reducing or excluding sugars in coatings appropriate for humans can negatively impact texture, appearance, and overall functionality, which would make the resulting coatings unsuitable for achieving an enjoyable experience for both pets and pet parents.

High fat content in coatings suitable for human consumption often also play a role in structure, texture, and flavor of such coatings. However, while pet foods should contain sufficient fat to maintain pet health, too much fat consumption can play a role in pet obesity and other health problems. As with sugar, fat cannot simply be reduced or removed from coatings suitable for human consumption to make them suitable for pet consumption because texture, appearance, and shelf stability will be impacted, which would result in poor performance in providing pet parents with an enjoyable way to feed their pets.

It was discovered, and is disclosed herein, that a particular combination of non-fat solids and a fat composition having a melting point of 90° F. to 140° F. can be used to produce a veneer that has a low sugar content (e.g., no more than 25% by weight of the veneer) and a low moisture content (e.g., less than 7% by weight of the veneer), and displays a smooth appearance at room temperature and is surprisingly transport stable at 100° F. for at least 24 hours.

A veneer described herein includes non-fat solids in an amount of about 40% to about 60% (e.g., about 45% to about 58%) by weight of the veneer. As used herein, “non-fat solids” refers to any solids content at room temperature that is not contributed by a triglyceride or other lipid molecule. Since a veneer described herein has a low moisture content, non-fat solids are generally undissolved in the veneer. Examples of non-fat solids include, without limitation, protein, sugar, non-sugar carbohydrates (e.g., starches, fibers, polysaccharides, and the like), minerals, and the like. Any appropriate ingredient, preferably dry (e.g., a moisture content of less than 7%, less than 5%, or less than 4%), can be used to provide the desired non-fat solids content. For example, flours (e.g., oat flour, potato flour, rice flour, pea flour, and the like), nut butters (e.g., peanut butter, almond butter, and the like), milk ingredients (e.g., non-fat dry milk, milk powder, and the like), egg ingredients (e.g., egg white powder, whole egg powder, and the like), starches (e.g., tapioca starch, potato starch, rice starch, and the like), protein powders (e.g., pea protein isolate, potato protein, milk protein concentrate, chicken protein powder, and the like), or other edible ingredients (e.g., bone meal, beef broth powder, and the like).

In some embodiments, a veneer can have a protein content of at least 5% (e.g., about 6% to about 25%, or about 7% to about 20%) by weight of the veneer. Protein content of a veneer can be contributed from one or more ingredient, including, without limitation, protein powders, milk ingredients, nut butters, flours, and the like.

Sugar can contribute to a non-fat solids content of a veneer in an amount of up to 25% (e.g., up to 10%, or up to 8%) by weight of the veneer. In some embodiments, a veneer contains less than 2% (e.g., less than 1%, or 0%) by weight of the veneer. In some embodiments, a veneer provided herein can contain essentially no (e.g., less than 0.5%, less than 0.1%, or 0% by weight of the veneer) refined sugar, even if some unrefined sugar is present. As used herein, a “sugar” is a monosaccharide or a disaccharide. A “refined sugar,” as used herein, refers to sugar that is extracted, purified, or condensed from its original source. Examples of refined sugars include, for example, powdered sugars (e.g., cane sugar, table sugar, brown sugar, and the like) and syrups (e.g., corn syrup, rice syrup, honey, molasses, and the like.

As used herein, sources of sugar that are considered unrefined sugar include milk ingredients (e.g., whole milk, skim milk, powdered milk, non-fat dry milk, and the like); fruit, nut, or vegetable purees, pulps, and pastes; fruit, nut, or vegetable powder; non-sweetened fruit pieces; non-sweetened dried fruit; the sugar portion of inulin and other fiber ingredients; and the like.

A fat composition can be included in a veneer described herein in an amount of about 35% to about 60% (e.g., about 35% to about 55%) by weight of the veneer. A fat composition included in a veneer has a melting point of 90° F. to 140° F. (e.g., about 95° F. to about 120° F.). A fat composition can include any edible fat, including a single fat (e.g., a single fractionated palm oil stearin, a fractionated tallow, or the like), or two or more fats that are combined, with or without interesterification. Suitable fats for use in a fat composition include fats from plants (e.g., palm oil, palm kernel oil, canola oil, olive oil, peanut oil, and the like, or any fraction thereof), animals (e.g., milk fat, tallow, and the like, or any fraction thereof), or microorganisms (e.g., algae, bacteria, and the like, or any fraction thereof).

In some embodiments, when a fat composition in a veneer has a melting point at or above 120° F. (e.g., 120° F. to 140° F.), the veneer can include at least 10% (e.g., 10% to about 25%) protein by weight of the veneer. In such embodiments, protein content can help reduce bloom appearance on the surface of a veneer over shelf life.

In some embodiments, a fat composition can include a hard fat having a melting point above 140° F. (e.g., 140° F. to about 160° F., 140° F. to about 150° F., or 140° F. to about 145° F.) in an amount of up to 40% (e.g., up to about 35%) by weight of the fat composition. Examples of suitable hard fats having a melting point above 140° F., include without limitation, stearin fractions of fats and fully hydrogenated fats. A double fractionated palm oil stearin is a particularly useful hard fat suitable for use in a fat composition.

In some embodiments, when a veneer contains a non-fat solids content greater than 55% (e.g., about 56% to about 60%) by weight of the veneer, the veneer can contain a fat composition that contains at least 2% (e.g., 2% to 40%, or about 10% to about 30%) hard fat by weight of the fat composition. In such embodiments, hard fat content can help improve smooth appearance of a veneer.

In some embodiments, when a fat composition contains 0% by weight hard fat, the fat composition can have a melting point that is at least 100° F. (e.g., 100° F. to 140° F., or about 105° F. to about 130° F.). In such embodiments, a melting point of at least 100° F. can help improve transport stability and finished product quality of a veneer.

In some embodiments, a fat composition can include a liquid fat having a melting point below 90° F. (e.g., below 70° F., or below 50° F.) in an amount of up to 30% (e.g., up to 25%, or up to 20%) by weight of the fat composition. Any edible liquid fat can be used, such as peanut oil, canola oil, olive oil, algae oil, and the like, or liquid fractions of higher melt point fats. In some embodiments, at least a portion of a liquid fat in a fat composition can be contributed by a nut butter, such as a peanut butter or almond butter, included in a veneer (e.g., in an amount of up to 40%, or up to 30%, or about 25% by weight of the veneer). In some embodiments, at least a portion of a liquid fat in a fat composition can be contributed by an oil-based flavorant.

As used herein, melting point is measured as the Mettler Dropping Point of a fat composition.

In some embodiments, a veneer can contain essentially no corn-derived, wheat-derived, and/or soy-derived ingredients. That is, in some embodiments, a veneer can contain essentially no soy-, corn-, and/or wheat-derived oil, flour, protein, starch, or the like. A veneer described herein remains transport stable and smooth in appearance despite exclusion of these ingredients, which are often used to provide stable structure, appearance, and function of foods for both humans and pets.

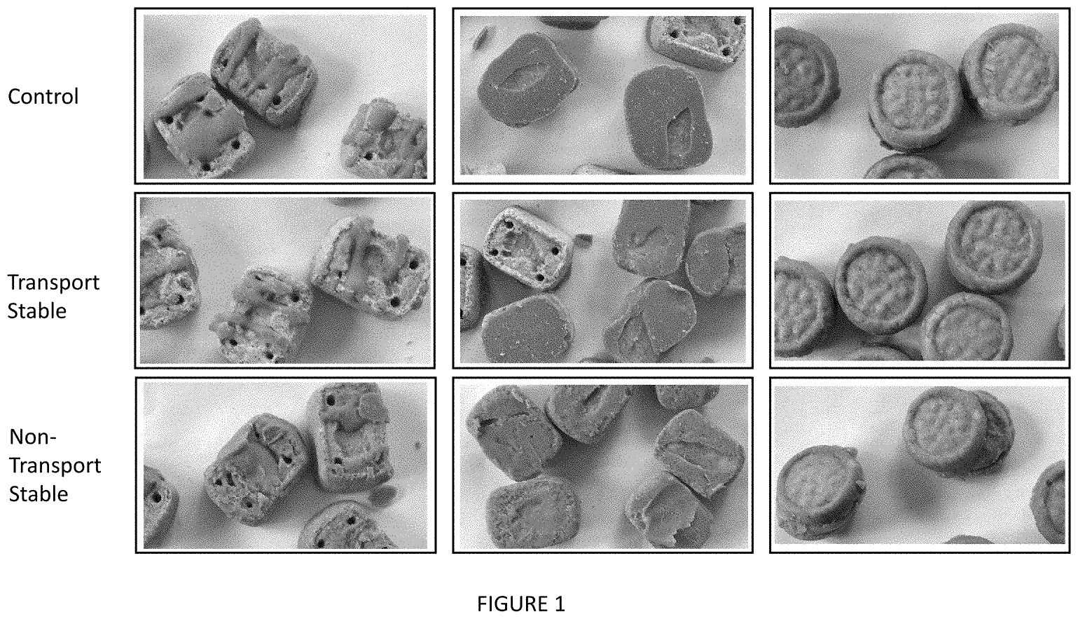

As used herein, the term “transport stable” refers to structural and appearance stability relative to a control during a transport test. A transport test is measured by subjecting a veneer on a base food piece in its intended packaging format (e.g., individually wrapped, or in a pouch with multiple pieces inside) to a temperature of 100° F. for an extended period of time (e.g., at least 12 hours, or at least 24 hours) while being shaken. A veneer is considered transport stable if, after the transport test, there is substantially no visible smearing, melting, displacement of the veneer onto packaging or adjacent pieces, or shifting of pieces for a sandwiched product, relative to a control that is maintained at room temperature with no shaking over the same period. See, for example, FIG. 1. In some embodiments, a veneer can exhibit substantially no visible smearing, melting, chipping, displacement of the veneer onto packaging or adjacent pieces, or shifting of pieces for a sandwiched product when the veneer on a base food piece is subjected to a temperature of about 113° F. for 4 hours with shaking.

A base food piece in a pet food provided herein is suitable for pet consumption and is sufficiently structured to support a veneer as described herein. A base food piece can be hard or soft, and can be in any form, such as a kibble, a biscuit, a cookie, or the like. Generally, a base food piece has a moisture content of less than 15% (e.g., from about 3% to about 12%, or about 8% to about 11%). In some embodiments, a base food piece can contain a low sugar content (e.g., no more than 25%, up to 10%, up to 8%, less than 2%, less than 1%, or 0% by weight of the base food piece). In some embodiments, a base food piece can contain essentially no refined sugar. In some embodiments, a base food piece can contain essentially no corn-derived, wheat-derived, and/or soy-derived ingredients.

In some embodiments, a method of making a pet food provided herein can include providing a base food piece having a surface and applying a liquid composition to the surface, where the liquid composition solidifies to produce a veneer described herein. In some embodiments, a liquid composition can be made by providing at least a portion of a fat composition in a liquid state and combining the fat composition with other ingredients to achieve a non-fat solids, fat composition content, sugar content, and moisture content appropriate for a veneer described herein. In some embodiments, one or more component of a fat composition (e.g., a fat in a nut butter or a milk ingredient) can be added separately from one or more other component of a fat composition (e.g., a hard fat) with other ingredients to make a liquid composition.

In some embodiments, ingredients can be combined as appropriate to achieve a non-fat solids, fat composition content, sugar content, and moisture content appropriate for a veneer described herein, and the combined ingredients can be heated to achieve the liquid composition. In some embodiments, a liquid composition is at a temperature at or above the melting point of a fat composition included in a veneer, but a temperature below that which would reduce the quality of any ingredients (e.g., flavorants, proteins, and the like) in the veneer. In some embodiments, a liquid composition can be held at a temperature above that which would reduce the quality of any ingredients, but at a time insufficient to reduce the quality of the ingredients.

In some embodiments, a liquid composition can be produced by combining ingredients at a temperature below the melting point of a fat composition included in a veneer to achieve a non-fat solids, fat composition content, sugar content, and moisture content appropriate for a veneer described herein. In some embodiments, a liquid composition can be produced at a temperature of from about 60° F. to about 90° F. That is, in some embodiments, one or more fat in a fat composition having a melting point above 90° F. can be in a solid or semi-solid state when combined with other ingredients to produce a liquid composition. As used herein, a “liquid composition” refers to a composition that can be pumped to be applied to a surface of a base food piece. A liquid composition can have any viscosity that allows it to be pumped (e.g., at a temperature from about 50° F. to about 150° F.).

A liquid composition can be applied to a surface of a base food piece using any appropriate method. For example, a liquid composition can be drizzled on a surface to provide a decorative design. In another example, a base food piece can be dipped partially or completely into a liquid composition to apply a coating at least a portion of one or more surfaces of the base food piece. In another example, a liquid composition can be applied as a waterfall or spray to a base food piece to cover at least a portion of a surface. In another example, a liquid composition can be pumped into an indentation on a surface of a base food piece to cover at least a portion of a surface. In another example, a liquid composition can be extruded as a layer on a base food piece (e.g., as a filling between two food pieces) to cover at least a portion of a surface.

After a liquid composition is applied to a base food piece, it is allowed to solidify to form a veneer described herein. Generally, a liquid composition can be allowed to solidify by allowing the liquid composition to cool. A liquid composition need not cool to a point at or below the melting point of a fat composition included in the liquid composition for the veneer to solidify. In some embodiments, a liquid composition on a surface of a food piece can be exposed to a chilled environment (e.g., a cooler or a freezer) to accelerate solidification of a liquid composition to form a veneer.

A pet food provided herein can be packaged after manufacture using any appropriate equipment and packaging. A pet food can be packaged with multiple pieces in a single package or packaged individually. In some embodiments, individual pieces of a pet food provided herein can be wrapped, then individually wrapped pieces can be packaged together for sale.

A pet food described herein can have a shelf life at room temperature of at least 6 months (e.g., at least 9 months, or at least 12 months), where the pet food maintains a substantially stable appearance and pet palatability.

The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A pet food, comprising:
a. a base food piece; and
b. a veneer on a surface of the base food piece, the veneer including:
i. a non-fat solids content of about 40% to about 60% by weight of the veneer;
ii. a fat composition in an amount of 35% to 60% by weight of the veneer, the fat composition having a melting point of 90° F. to 140° F. and including a hard fat in an amount of up to 40% by weight of the fat composition, the hard fat having a melting point greater than 140° F.;
iii. a sugar content of up to 25% by weight of the veneer; and
iv. a moisture content of less than 7% by weight of the veneer;
wherein the veneer is transport stable at 100° F. for at least 24 hours and has a smooth appearance at room temperature.

2. The pet food of claim 1, wherein the fat composition includes up to 30% by weight of a liquid fat having a melting point below 90° F.

3. The pet food of claim 1, wherein the veneer has a protein content of at least 5% by weight of the veneer.

4. The pet food of claim 3, wherein the protein content of the veneer is from about 6% to about 30% by weight of the veneer.

5. The pet food of claim 1, wherein the veneer contains at least 10% by weight protein when the fat composition has a melting point at or above 120° F.

6. The pet food of claim 1, wherein the fat composition includes the hard fat in an amount of at least 2% by weight when the non-fat solids content is greater than 55%.

7. The pet food of claim 1, wherein the melting point of the fat composition is at least 100° F. when the hard fat content of the fat composition is 0%.

8. The pet food of claim 1, wherein the veneer comprises a nut butter.

9. The pet food of claim 1, wherein the sugar content of the veneer no more than 10%.

10. The pet food of claim 9, wherein the sugar content of the veneer is 0%.

11. The pet food of claim 1, wherein the pet food contains essentially no refined sugar.

12. The pet food of claim 1, wherein the pet food contains essentially no corn-derived, wheat-derived, or soy-derived ingredients.

13. The pet food of claim 1, wherein the pet food has a shelf life of at least 6 months at room temperature.

14. A method of making a pet food, the method comprising;
a. providing a base food piece having a surface;
b. applying a liquid composition to the surface, the liquid composition including:
i. a non-fat solids content of about 40% to about 60% by weight of the liquid composition;
ii. a fat composition in an amount of 35% to 60% by weight of the liquid composition, the fat composition having a melting point of 90° F. to 140° F. and including a hard fat in an amount of up to 40% by weight of the fat composition, the hard fat having a melting point greater than 140° F.;
iii. a sugar content of up to 25% by weight of the liquid composition; and
iv. a moisture content of less than 7% by weight of the liquid composition; and
c. allowing the liquid composition to solidify to form a veneer on the surface to produce the pet food, wherein the veneer is transport stable at 100° F. for at least 24 hours and has a smooth appearance at room temperature.

15. The method of claim 14, further comprising producing the liquid composition.

16. The method of claim 15, wherein the liquid composition is produced at a temperature below 90° F.

17. The method of claim 15, wherein the liquid composition is produced at a temperature at or above the melting point of the fat composition.

18. The method of claim 14, further comprising packaging the pet food into a package.
